(19) United States
(12) Patent Application Publication
(10) Pub. No.: US 2008/0204873 A1
(43) Pub. Date: Aug. 28, 2008

(54) TECHNIQUES FOR THREE DIMENSIONAL DISPLAYS

(75) Inventor: Stephen Daniell, Northampton, MA (US)

Correspondence Address: JOHN F. KACVINSKY, C/O INTELLEVATE, P.O. BOX 52050, MINNEAPOLIS, MN, 55402, US

(73) Assignee: Strategic Patent Acquisitions LLC, Wexford, PA (US)

(21) Appl. No.: 12/014,837

(22) Filed: Jan. 16, 2008

Related U.S. Application Data
(60) Provisional application No. 60/891,420, filed on Feb. 23, 2007.

(51) Int. Cl. G02B 27/22

(52) U.S. Cl. 359/463; 359/462

(57) ABSTRACT

Techniques for three dimensional displays are described. An apparatus may comprise a first prism array having a first set of faceted prism elements arranged to optically couple with a second prism array having a second set of faceted prism elements, the first prism array and the second prism array to provide a null refractive component when the first set of faceted prism elements are in a first position relative to the second set of faceted prism elements, and a directional refractive component when the first set of faceted prism elements are in a second position relative to the second set of faceted prism elements. Other embodiments are described and claimed.

### CROSS-REFERENCE TO RELATED APPLICATION

This application claims priority and benefit from U.S. Provisional Application Ser. No. 60891420 filed Feb. 23, 2007 and titled “Electable 2D/3D Display,” the entirety of which is hereby incorporated by reference.

### BACKGROUND

Displays which allow the user to see an illusion of stereoscopic depth without glasses or other viewing aids are known as autostereoscopic displays. These systems generally work by selectively directing pixels to the right and left eyes so that the two eyes are provided with images made from slightly differing perspectives. These two perspectives, once seen, are cognitively conjoined into a depth model of the scene represented in the two distinct retinal images.

In order to obtain a separation of left and right view data, an autostereoscopic display is provided with an expressly devised selective optical system. When a compact form-factor is desired, the solution chosen is typically micro-optical, as this allows the optical structure to lie near the display plane. Depending on the solution, the micro-optical materials may be located behind, within, or in front of the display.

Because a monolithic device such as a flat panel display must often serve as the image source for both the right and left views, however, horizontal resolution is usually reduced in proportion to the number of views provided. A two-view, horizontal parallax-only system will therefore characteristically halve the horizontal resolution of the base display. It has so far been impossible to operate a flat panel at its full native capability without sacrificing its performance in some other display domain. It has been found that stereoscopic imaging, and imaging in general, however, can be highly effective at resolutions lower than that demanded by text rendering.

As a result, it has been found that many potential users are seeking devices that can exhibit images alternately in three dimensions (3D) and in two dimensions (2D), but which avoid sacrificing the overall isometric resolution when operated in 2D mode. Applications of these displays are not limited to desktop or laptop use. For example, digital camera technologies are known that can capture a 3D image from 2D image records. A flat panel image viewer on a camera back could be enabled to replay stereoscopic content. Nevertheless, for standard operation and optimal utility, it may also be considered important or useful that the 2D image directly anticipate standard rasterized 2D digital output. A full-time 3D display here is not a preferred or economical solution.

Similarly, many game systems are enabled already for stereoscopic output. Some game software designers work only with 2D graphics, however, so that it is desirable that the display always be operable in the optimal mode of use envisioned by the game designers. As another example, product designers and architects often toggle between detailed 2D sectional views and 3D visualizations as a natural function of a project's evolutionary workflow. In each case above, the desire for stereoscopic output is coupled with a parallel desire to retain the conventional 2D display parameter.

Permanently modified 3D displays are generally unable to accurately display images that have been designed only for 2D display, such as digital photos, digital video, computer desktops, type fonts, sectional medical scans, and conventional 2D game content. Therefore, is highly valuable to have a 3D display that can revert to operation in conventional 2D mode at the native resolution of the base display.

Compact autostereoscopic displays can use vertically striped barrier filters, light lines, lenticulars, or, less commonly, microprisms. Lenticulars and microprisms can provide a bright image, and are preferred for image quality. Their refractive micro-optical systems, however, are difficult to disable. Therefore, existing commercial 2D/3D convertible displays predominantly rely on light lines or barrier filters.

Although their practice differs somewhat, the geometrical principle of light lines and barriers is similar, each providing selective pixel illumination with alternating darkened stripes that are set apart from the plane of the display panel. Right and left images are horizontally interlaced in alternating columns. The visual pathway for the right eye is prevented from accessing the pixels dedicated to the left view, and the left eye is prevented from seeing the pixels for the right. This selection is made by optical parallax, observed via a vertically lineated filter structure. The filter is set apart from the plane of the pixel apertures, and devised in such a way that the pitch of the filter anticipates the viewer's position and lines-of-sight. In a barrier display, the angular filtering is provided by a black pattern, such as lines or squares, formed upon an otherwise transparent planar material. In a display using light-lines, columns of pixels are selectively illuminated by a light source guided into vertical linear channels and offset behind the plane of the display apertures.

A pattern of opaque vertical lines can be made electively 2D or 3D by using a lineated LCD display laminated on top of a conventional LCD panel. Typically, liquid crystal domains are locally controlled so that opposing polarizations cause light from a subset of pixel apertures to be blocked. Half of the pixel columns are obstructed in an electronically addressable manner so that a 3D image may be observed, as in a fixed barrier display. In the case of light-lines, the illumination sources for the alternating vertical light lines can differ, so that the complete set of pixels can electively be illuminated such that they are seen by both eyes in 2D mode.

Both of these designs provide operation in 2D mode at the full resolution of the base display. They both compromise the image structure, however, to the extent that each column is provided with a neighboring occluded column as wide as, or wider than, the pitch of the pixel columns. Unless this dimension is below the retinal threshold, the observer sees a distracting striated pattern. Furthermore, at least half the normal output illumination level is sacrificed to the angular filtering process. This dimming makes this class of 3D displays inefficient, particularly for battery-powered portable applications, such as laptop computers, portable games, and personal electronic devices.

Solutions for a 2D/3D display have therefore been sought which might operate by refraction rather than occlusion, given that refraction does not intrinsically disrupt the image structure or absorb light in the process of angular filtering. Lenticular arrays have been widely used to create autostereoscopic imagery. Detaching and repositioning a lenticular lens array, however, is impractical due to stringent alignment tolerances and likelihood of damage.

It has been observed that the light-bending effect of a lenticular array can be subverted if the refractive surface is rendered effectively null by the placement of an index-matched material between the lenticular micro-optical relief and a plane surface. Methods have been proposed using solid transparent material (Eichenlaub U.S. Pat. No. 5,500,765) in the form of a hinged negative-lens array sheet, and by the introduction of transparent liquid (Lipton US Application 20020036825). Preservation of the optical integrity of a second removable lens sheet is difficult, however, as is the rapid, complete and reliable removal of an index-matched optical fluid.

A type of polarization-based convertible lenticular display proposed by Woodgate (GB2389192) provides full illumination in 3D mode. The birefringent liquid crystal is electrically reoriented so that an index disparity is optionally created at a lenticular interface. In the alternate LC orientation, the indices of the liquids crystal and the lenticular enclosure are matched so that the component is effectively transparent. This approach, however, requires that the input polarization be rotated via 90° to alter the mode of use from 2D to 3D, and vice versa. This requires either a physical rotation of a polarizer, which must be at least equal to the size of the display, or an electronic rotation of the polarization state of a specially engineered material in place of a conventional, inexpensive fixed polanzer.

Therefore, it may be understood that the desire for intermittent stereoscopic 3D display capability is widespread, yet that existing 2D/3D displays either provide suboptimal display quality, or demand significantly increased cost or complexity. Current 3D displays are therefore unlikely to access the wide range of applications for which they are potentially suited.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, for example, an apparatus may comprise a first prism array having a first set of faceted prism elements arranged to optically couple with a second prism array having a second set of faceted prism elements. The first prism array and the second prism array may provide a null refractive component when the first set of faceted prism elements are in a first position relative to the second set of faceted prism elements, and a directional refractive component when the first set of faceted prism elements are in a second position relative to the second set of faceted prism elements. For example, the first prism array and the second prism array may provide two dimensional resolution when in the first position and three dimensional resolution when in the second position. Other embodiments are described and claimed.

### BRIEF DESCRIPTION OF THE DRAWINGS

FIG. 1 shows a schematic prism array formed according to a prior practice.

FIG. 2 represents the subset of prism array solutions for which right (R) and left (L) image data cells are independently aligned with a right viewpoint (RV) and a left viewpoint (LV).

FIG. 3 shows how sight-lines from a presumed right and left viewer positions are used to define right and left view separation points.

FIG. 4A shows a single two-facet prism element.

FIG. 4B illustrates how a three-faceted prism element may serve to mitigate these viewing defects.

FIG. 4C shows in principle that a four-faceted prism element may further serve to mitigate these viewing defects,

FIG. 5A illustrates schematically that if a viewer approaches the image, visually accessed zones L1 and L2 become closer together.

FIG. 5B illustrates schematically that if the viewer recedes from the image, visually accessed zones L1 and L2 separate.

FIG. 5C illustrates schematically that if the observer moves to the side, both visually accessed zones shift in a common direction.

FIG. 6 shows a pair of divided biprism arrays in which the refractive power of the system has been divided in half and is shared by the two biprism array surfaces.

FIG. 7 represents an alternate relative positioning of the two divided biprism arrays in which the apices of two arrays are shifted laterally, relative to one another.

FIG. 8 depicts a fresnel biprism array in which the each facet had been decomposed into a plurality of sloped zones.

FIG. 9A shows that such an array may also be divided in optical power between two optical surfaces.

FIG. 9B shows an alternate relative position of prism arrays displaced relative to the configuration of FIG. 9A by a predetermined lateral distance.

FIG. 10A shows two facing asymmetric prism arrays.

FIG. 10B shows that arrays of FIG. 10A may be displaced through a predetermined distance to restore facets to provide local parallelism.

FIG. 11 shows two three-facet arrays in a facing arrangement.

FIG. 12 shows two four-facet arrays in a facing arrangement.

FIG. 13A shows asymmetric contiguous three-facet arrays and disposed in a facing arrangement.

FIG. 13B shows asymmetric contiguous three-path arrays and disposed in a facing arrangement, in an arrangement in which a stereoscopic image can be presented.

FIG. 14 shows facing asymmetric fresnel arrays that are optically analogous to the array in FIG. 13A and 13B, but which include a fresnel step in each facet.

FIG. 15 shows a detail of the surface relief of FIG. 14.

FIG. 16 shows an asymmetric plano prism array which includes incused prism facets.

FIG. 17A shows the 3D mode in which facets are laterally displaced from one another to produce a light steering effect.

FIG. 17B shows the same arrays displaced so that all opposing facets in the arrays are placed in parallel planes.

FIG. 18A shows facing contiguous four-facet arrays disposed in a relationship that permits 3D viewing.

FIG. 18B shows that the steering effect can be annulled by translating the relative position of the arrays of FIG. 18A.

FIG. 19A shows facing four-facet fresnel arrays having four angular zones.

FIG. 19B shows that relative displacement of the arrays of FIG. 19A makes all facets and subfacets parallel with their opposite counterparts.

FIG. 20A shows how the region of the display plane AB is reduced by angular vignetting.

FIG. 20B shows how the region of the display plane AB is less affected by angular vignetting when fresnel zones are used.

FIG. 21 illustrates how two-facet array can conceptually be modified from two facets to four.

FIG. 22 shows an abstraction of a four-facet design without the presumption of continuous facet slopes or contiguous facet edges.

FIG. 23A shows that a centered viewer would see four identical optically replicated images.

FIG. 23B illustrates a left icon shifted to the center of the left half of display cell.

FIG. 23C illustrates a right icon placed at the center of the right half of display cell.

FIG. 24 shows that differing image data may be included within each prism array cell.

FIG. 25 shows diagrammatic quantized display including one right-pixel RGB triad and one left-pixel RGB triad.

FIG. 26 shows one schematic asymmetric prism array, effectively half of a switching 2D/3D prism system.

FIG. 27 shows a cutaway perspective view of an exemplary flat-panel display formed according to one embodiment, having two columns of pixels per display cell.

FIG. 28 shows the display plane color filter pattern of the display FIG. 28 in more detail.

FIG. 29 depicts a design in which RGB stripe filters are oriented vertically, and RGB pixels are interlaced.

FIG. 30 shows a system using four pixels per cell that enables highly robust active updating of the display at the subpixel level.

FIG. 31 shows the display plane color filter pattern of the display FIG. 30 in more detail.

FIG. 32 shows a variation in which the pixel apertures are made expressly elongate.

FIG. 33 shows notebook computer 90 having a 2D/3D display screen formed according to one embodiment.

FIG. 34A shows redundant pixel domains are disposed in six-subpixel-wide columns in a first tracked position.

FIG. 34B shows redundant pixel domains are disposed in six-subpixel-wide columns in a second tracked position.

FIG. 35 illustrates one embodiment of a logic flow.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, one embodiment may include more or less elements in alternate arrangements as desired for a given implementation. It is worthy to note that any references to “one embodiment” or “an embodiment” are not necessarily referring to the same embodiment.

Various embodiments describe novel methods and devices that allow a conventional 2D display to be activated in order to electively show stereoscopic three-dimensional imagery. In some embodiments, two facing prism arrays of predetermined design are located in front of a display. The conversion from 2D to 3D occurs when a relative lateral motion, typically of a distance equal to a predetermined prism facet pitch, is imparted between the two optical arrays.

In one embodiment, two identical prism arrays including a plurality of bevel prisms elements are disposed so that their relief faces are in proximity. The second prism array has a relief that is oriented in a predetermined complimentary geometry to the first. The two prism arrays are devised so that, in a first positional relationship, all opposite facets are parallel and they may be aligned or mated to provide an effectively null refractive component.

When these complementary arrays are displaced from one another through a distance equal to a fraction of a prism element, they occupy a second positional relationship, and a directional refractive effect is introduced, so that differing visual data may be consistently directed to the right and left eyes to produce a stereoscopic effect. Restoring the previous mating or alignment of the prismatic reliefs causes the display to revert to the full 2D resolution of the base display.

The displays may be shifted directly by the user, or indirectly through an electromechanical linkage. The system may be devised to have bistable operation, so that no power input is required except during transition between 2D and 3D modes. The two prism arrays can be identical to one another, and can be applied to standard electronic media such as LCDs and OLED displays. The prism arrays can be made inexpensively in plastic. The base display can regularly employ common substrate thicknesses (e.g. 0.7 mm LCD glass) and pixel arrangements (e.g., RGB stripe). Because the prisms do not magnify the pixels, some embodiments can be used to circumvent the moire banding seen in lens-based systems, such as lenticulars. Specific embodiments of the system are adaptable to observer-tracking and viewpoint-adaptive image display.

Additionally, pixel columns are never obstructed as they are in barrier displays. Moreover, images viewed in 3D mode in a specific embodiment may even be arranged to yield a brightness level that is considerably greater than it would be in normal 2D mode. This property may electively be employed as a power-saving option in, for example, a battery-driven portable device. Specifically, relative to switchable barrier displays, some embodiments can exhibit triple the brightness of the observed image given the same backlight illumination levels. This increase is obtained using a microoptical structure that also yields a relative increase in the orthoscopic viewing zone when the display is in 3D mode.

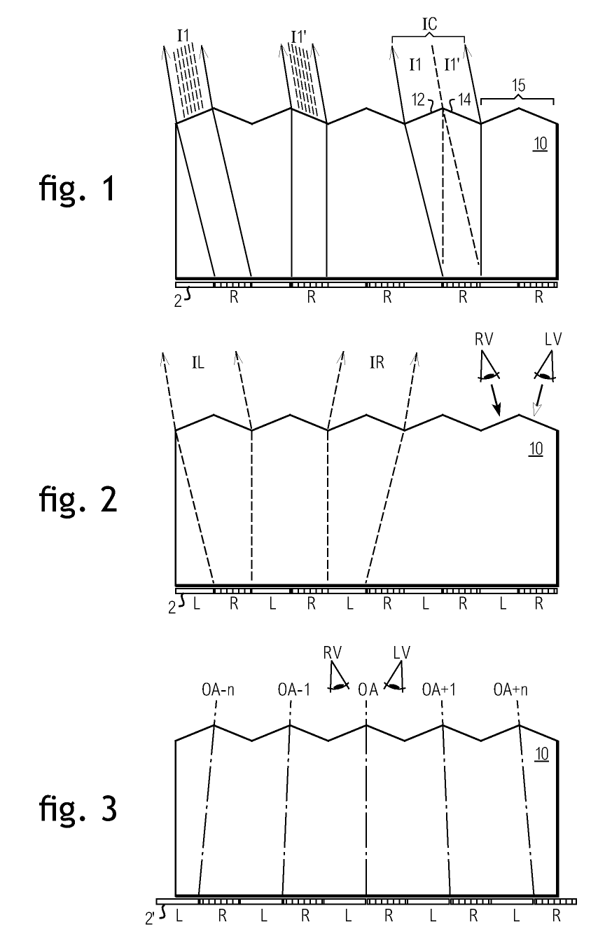

The nature of one embodiment may be understood in reference to, and in a progression from, the conventional use of prism arrays in dividing right and left views for autostereoscopic imaging. Prism arrays have occasionally been used in the past to provide an autostereoscopic image. A common historical implementation is illustrated in FIGS. 1 through 4A. Prism elements 15 in these figures exhibit symmetry about the apex of each prism. Each element therefore included two symmetric surfaces 12, 14. A plurality of such elements is included in prism array 10. A prism array of sufficient spatial frequency is know to be capable of reproducing an illusion of depth for a viewer at a preestablished location by optically decoding a special image that includes interlaced columns of pixels from right and left views. An equivalent effect may be obtained with elements including optical flats alternating with relatively prism elements of doubled slope (not shown). In this case, there would be a step at the edge of the element like that at the edge of a ring zone in a fresnel lens. This type of prism array has less regularly put in practice.

The following general description of the structure and operation of one embodiment is followed by instructions for the evolution of designs, via particular equations, to specific solutions. Round numerical values for a range of input design variables are set out in TABLE 1 and describe a range of embodiments of one embodiment. TABLE 2 is a reference guide relating different classes of displays within one embodiment to the figures.

Some embodiments may employ facing pairs of prism arrays in which the individual faceted prism elements are bilaterally asymmetric about the central vertical axis of the element. This property allows a diverse set of prism array pairings to be developed which have the ability to perform an angular division of light that in a manner that is particularly adapted to displays intended for intermittent use in an autostereoscopic mode.

For the purposes of clarity, the description here is limited to linear prism elements which can, in passive form, produce only stereoscopy and horizontal parallax. Full optical parallax systems with pyramidal features or layered optics on separate axes are also considered within the scope of the present embodiment. Additionally, full, active-parallax systems will be described which can be highly effective in displaying varying scene geometry while using only simple linear optics of the type employed in the following exemplary embodiments.

FIG. 1 shows a schematic prism array formed according a prior practice. The right-eye visual information from an arbitrary right visual data cell R in interlaced image 2 is shown reimaged as image I1 via typical first facet 12. Left-eye visual information from an arbitrary right visual data cell L in interlaced image display 2 is shown optically reproduced as image I1′ via typical first facet 14. The combined effect may be understood by the combined pathway IC shown in the right of the figure. If a proper relationship is established between 1) the array material's refractive index, 2) a prism element's angular slope, 3) the optical thickness of the display system, and 4) the viewer's distance from the display, visual data from a common locus of origin on interlaced image display 2 may be optically doubled, without magnification, in a consistent manner in each pair of neighboring facets. At the same time, the right and left eyes' sight-lines are directed in an exclusive manner to the alternating columns that carry the interlaced image data. When the prism surface including a plurality of prism elements 15 is then viewed directly by an observer from the design distance, a 3D image may be seen, without resort to head-mounted devices. In order to observe such stereoscopic depth, an observer must have differing image data presented to the right and left eyes.

FIG. 2 represents the subset of prism array solutions for which right and left image data cells R, L are independently aligned with right viewpoint RV and left viewpoint LV, respectively. For a given viewer position, optically duplicated columnar data IR and optically duplicated columnar data IL combine to form composite images which differ for the right and left eyes. Marginal column data, as shown in FIG. 2, would be misaligned with prism array elements for all but an infinite viewing distance. In practice, optical axis OA is defined for the array, and the relationship between prism elements and visual data cells R, L subtly altered so that a viewer's sight-lines from a given position will consistently align with the right and left view data. In practice, this is implemented by introducing a slight pitch disparity between the columnar interlacing of the underlying image and the prism array.

FIG. 3 shows that sight-lines from a presumed right and left viewer positions are used to define right and left view separation points. In the implementation shown, right positions OA−1 . . . OA−n are progressively shifted, as are left positions OA+1 . . . OA+n. The pitch of adjusted interlaced display 2′ is minutely larger than that of interlaced display 2, and allows for viewing an uninterrupted stereoscopic image at an elected finite distance. Analogous design conditions that anticipate a viewer location are regularly integrated in autostereoscopic displays such as lenticular and barrier displays, and these general principles and practices are hereby included by reference.

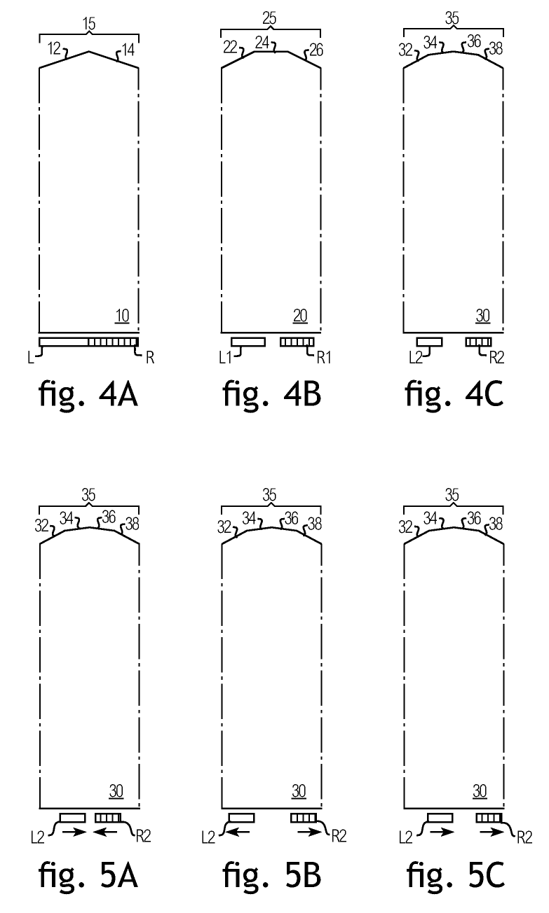

FIG. 4A shows single two-facet prism element 15 optically addressing left and right viewing zones L and R. Visually accessed zones L and R occupy equal areas of the backplane, each zone having essentially half the width of the prism element. A drawback of this design is that, as noted, the left and right views can only be perceptually separate for one observer position in the viewing field. Any other position will cause the observer's sight-lines to fall outside the assigned area. The observed views will inappropriately combine data from right and left display sources, undermining the image quality and the illusion of depth.

FIG. 4B illustrates how an element such as three-faceted prism element 25 included in three-faceted prism array 20 may serve to mitigate these viewing defects. Light from facets 22, 24, and 26 is controlled so that left and right visually accessed regions L1, R1 are essentially one-third of the width of three-faceted prism element 25. FIG. 4C shows in principle that four-faceted prism element 35 included in four-faceted prism array 30 may further serve to mitigate these viewing defects. In this case, visually accessed regions L2, R2 are seen via prism facets 32, 34, 36, and 38, and can be made to substantially occupy, in each instance, only one fourth of the width of the element.

FIGS. 5A-5C are application examples showing that a considerable margin of error may be allowed when four facets are employed. It is presumed for the purpose of demonstration that the design distance centers the visually accessed areas within the right and left columns of visual data. If a viewer approaches the image, visually accessed zones L1 and L2 become closer together, as shown schematically in FIG. 5A. If the viewer recedes from the image, visually accessed zones L1 and L2 separate, as shown schematically in FIG. 5B. If the observer moves to the side, both visually accessed zones shift in a common direction, as shown schematically in FIG. 5C.

From these figures, it may be understood that cross-talk between viewing zones, relative to a two-facet array, may be considerably counteracted by the conscientious introduction of plural facets. The size of the effective stereoscopic eye box may be increased. Furthermore, manufacturing tolerances may similarly be eased due to this configuration. A multiview interlacing, i.e. interlacing encompassing more than the minimal two views required for stereoscopy, may also electively be implemented.

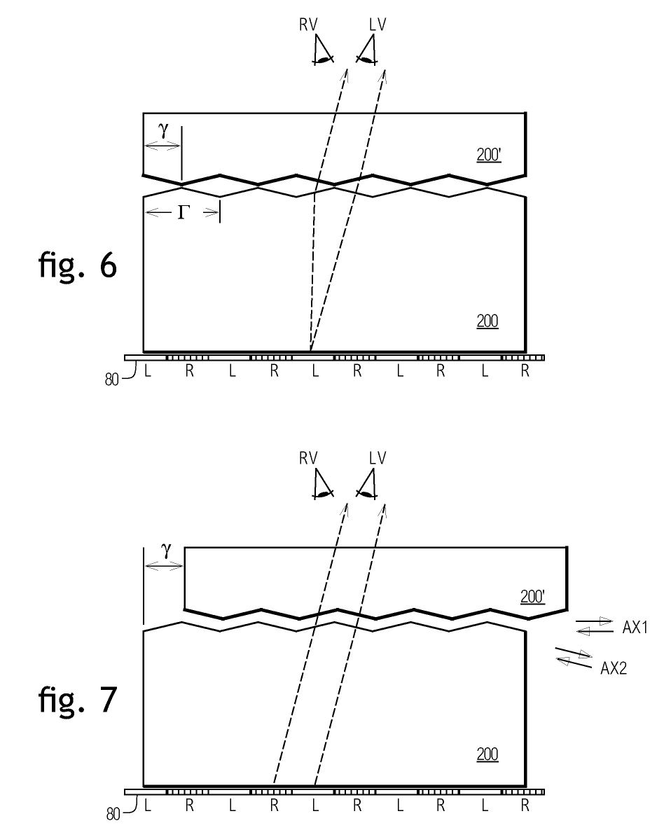

FIG. 6 shows a pair of divided biprism arrays 200, 200′ in which the refractive power of the system has been divided in half and is shared by the two biprism array surfaces. When the two arrays are combined, as in the configuration shown in FIG. 6, the summary effect can be made equivalent to that of an array of the sort shown in FIGS. 1 through 3. Divided biprism arrays 200, 200′ each have a facet pitch of y and an element pitch of F.

When the apices of the prisms are disposed so the apex of element 208 is aligned with the apex of element 208′, and the relative disposition is carried out effectively throughout the arrays, as the arrays are devised to be of a substantially common pitch. The eye at left viewpoint LV will access only data associated with the left perspective, as indicated by the dashed lines through the centers of the facets of a typical prism element. Display data 80 is thereby enabled to represent a stereoscopic image.

FIG. 7 represents an alternate relative positioning of the two divided biprism arrays. In this alternate positioning, the apices of array 200 and array 200′ are shifted laterally, relative to one another, so that the apices of one array is aligned with the synclines of the opposite array. This operation may be enacted through the directions of the arrows in the axis of the display AX1, or through the axis of the facet slope AX2. Displacement may also be made to occur through any intermediate or approximate axis. In either case, the displacement will be equal to y, as measured in a plane parallel to the display. It may be understood by reference to FIG. 7 that the two arrays may be aligned so the optical effect of the refractive facets is effectively annulled. In fact, if desired, the two facing arrays may be closely fitted together so that the combined effect of the two arrays is analogous to that of a planar sheet of transparent material.

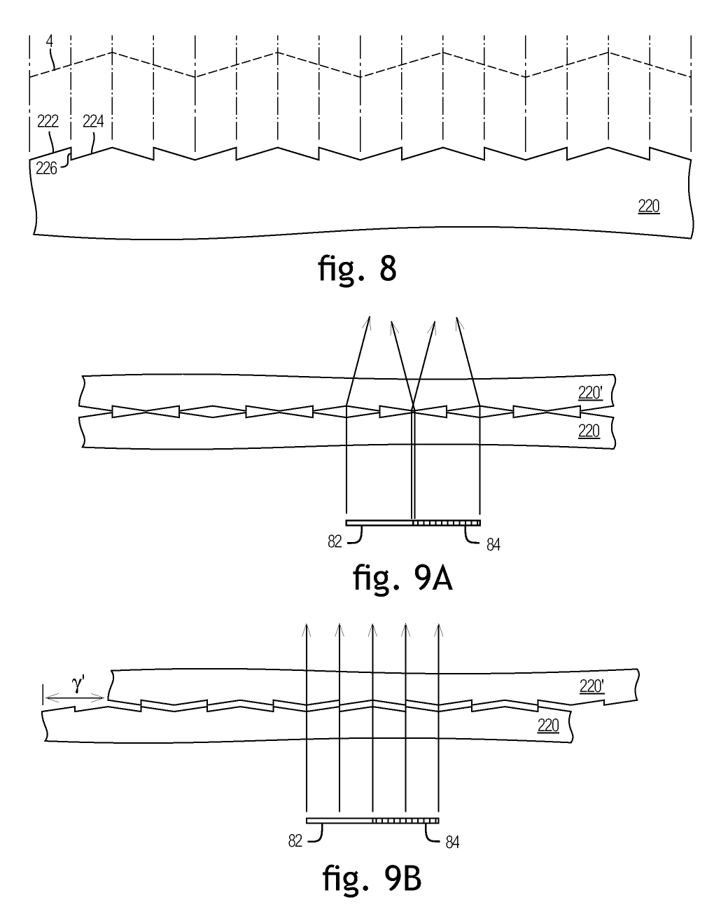

FIG. 8 depicts a fresnel biprism array in which the each facet had been decomposed into a plurality of sloped zones, represented by first biprism zone 222 and second biprism zone 224. Biprism zones are made contiguous by fresnel step 226. Each fresnel biprism 225 element includes two facets having opposite slopes 228, 228′. The fresnel surface is optically equivalent to biprism contour 4.

FIG. 9A shows that such an array may also be divided in optical power between two optical surfaces and nevertheless perform in effective manner to deviate right column data 82 and left column data 84 in a manner sufficient to represent stereoscopic depth.

FIG. 9B shows an alternate relative position of prism arrays 220, 220′. The arrays are shown displaced relative to the configuration of FIG. 9A by a lateral distance of g′, the half-pitch of element 225. In this case, the facets are made locally parallel, and there is no selective deflection of the right and left optical pathways.

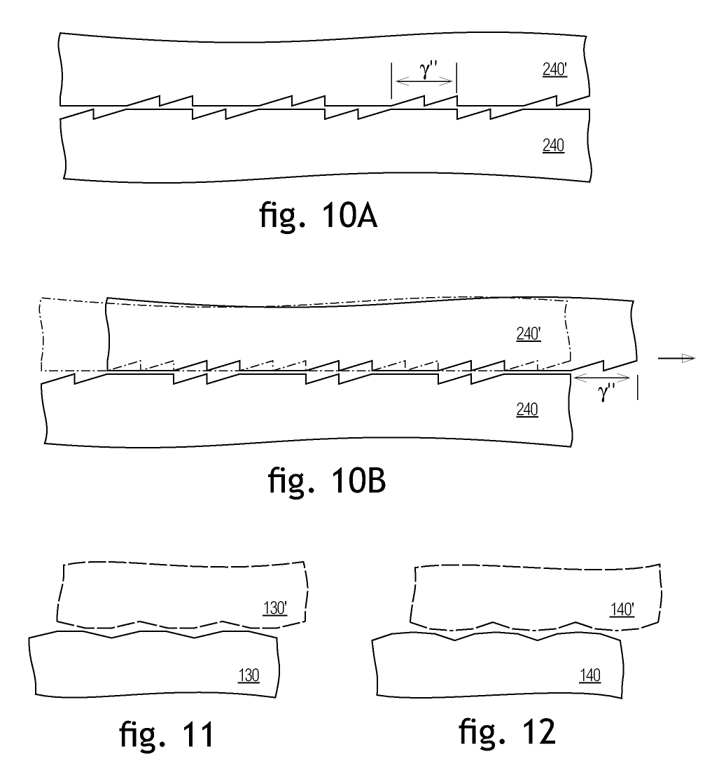

FIG. 10A shows two facing asymmetric arrays 240, 240′, including a plurality of elements 245 having a pitch g″. One or more facets 242, 244 contribute to refractive element 246, which alternates with optically flat regions 248. FIG. 10B shows that arrays 240, 240′ may be displaced through g″ to restore facets to provide local parallelism.

FIG. 11 shows first three-facet array 130 that includes a plurality of three-facet elements similar to the element illustrated in FIG. 4B. It may be understood by reference to FIG. 11 that there is no relative position of a first three-facet array and geometrically similar second three-facet array 130′ that can provide an alternate coupling in which the facets are made locally parallel. Therefore, the stereoscopic effect in such a design cannot be disabled by any lateral shift.

FIG. 12 shows that the same issue pertains to displays having four facets per element. Some local interfaces between first four-facet array 140 and second four-facet array 140′ will retain their power to diverge light, and therefore a display including two divided four-facet arrays of this configuration cannot be rendered optically neutral. Nevertheless, it would be desirable to obtain such an effect in a 2D/3D convertible display, since the display would have the improved viewing freedom previously discussed in reference to FIGS. 4B to 5C.

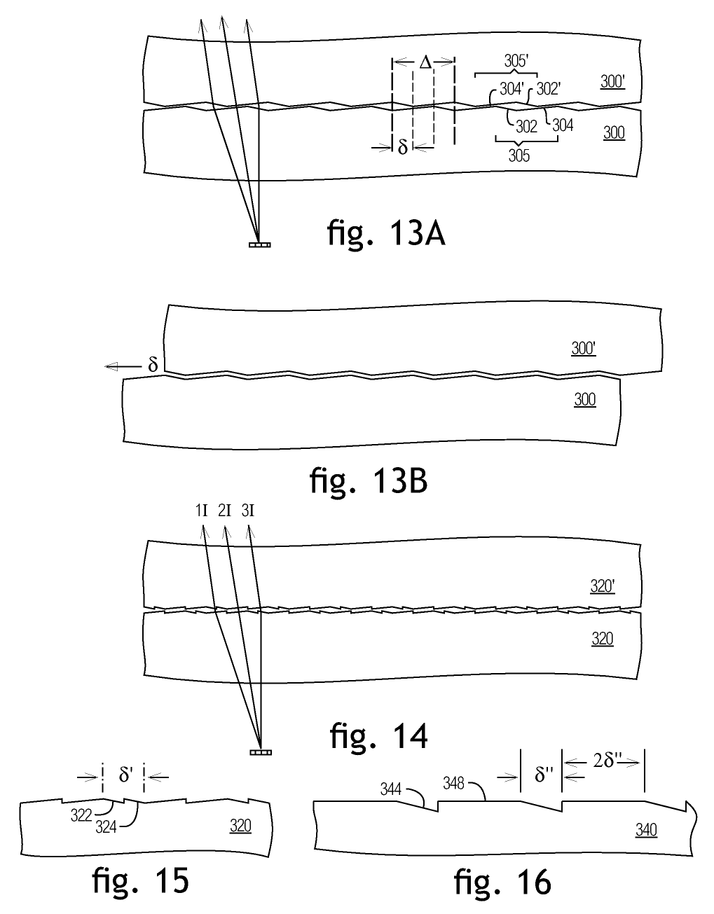

FIGS. 13A-19B shows various solutions within one embodiment that resolve the inability of such multifaceted arrays to be rendered neutral. Conscientiously extending the asymmetric practice depicted and described in arrays 240, 240′ allows various prism arrays to be devised such that the area targeted on the display plane by each eye is considerably smaller than the half-pitch of the element. Furthermore, in each illustrated case, the prism-induced stereoscopic effect may be neutralized by a small relative motion induced between the two arrays.

FIG. 13A shows asymmetric contiguous three-path arrays 300 and 300′ disposed in a facing arrangement. Contiguous two-facet asymmetric element 305 includes only facets 302, 304, yet, in combination with a series of two-facet asymmetric elements 305′, the facing arrays can be made to act in a manner analogous to a three-facet array such as that shown in FIG. 4B. In the relationship shown in FIG. 13B, a stereoscopic image can be presented. The effective element pitch D and the effective facet pitch d of the combined array assembly generated in the arrangement shown divide the element into three optically active regions, each having a different deflection angle. Facets in a given element convey light in a parallel manner from sources with three nonparallel original axes on the display plane, producing three replica images 1I, 2I, 3I that duplicate the appearance of region U.

FIG. 13B shows that relative displacement through a distance equal to the effective facet pitch d will make all facets in a given element convey from the display plane without significant deflection. The summary effect is again like that of a planar optical window.

FIG. 14 shows facing asymmetric fresnel arrays 320, 320′ that are optically analogous to the array in FIG. 13A and 13B, but which include a fresnel step in each facet so that an especially low relief is created.

FIG. 15 shows a detail of the surface relief of FIG. 14 and showing that smaller facet width d′ is physically divided into fresnel subfacets 322, 324. The height of the relief may be reduced by a factor equal to the number of zones into which each facet is partitioned.

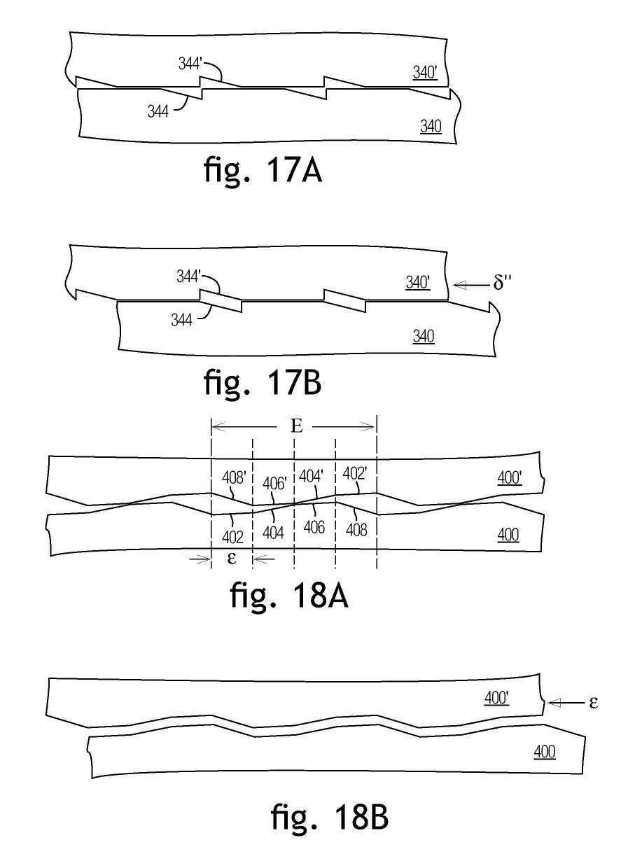

FIG. 16 shows asymmetric plano prism array 340 which includes incused prism facet 344 of a width d″ and plano face 348 of a width 2d″. FIGS. 17A and 17B show two such arrays 340, 340′ placed in a facing relationship.

FIG. 17A shows the 3D mode in which facets 344, 344′ are laterally displaced from one another to produce a light steering effect.

FIG. 17B shows the same arrays displaced through dimension d″ to align the facets in an opposite relationship so that all opposing facets in the arrays are placed in parallel planes. Incused prism embodiments of one embodiment may be used to reduce the exposure of fragile zone edges and prevent marring of sloped prism facets.

FIG. 18A shows facing contiguous four-facet arrays 400′ and 400′ disposed in a relationship that permits 3D viewing. Array 400 has an element width E and a facet width e such that e is one fourth of E. Each bilaterally asymmetric element shown is contiguous both within the element, and with its neighboring elements. Four facets 402, 404, 406, and 408 in array 400 and four facets 402′, 404′, 406′, and 408′ in array 400′ can be placed in alignment as shown to produce a prismatic steering effect similar to that of the four-faceted element in the monolithic system shown in FIGS. 4C through 5C. Facing arrays 400, 400′ have the same viewing freedom described for the monolithic array, but have the added property that the steering effect can be annulled by translating the relative position of the arrays laterally through e, FIG. 18B.

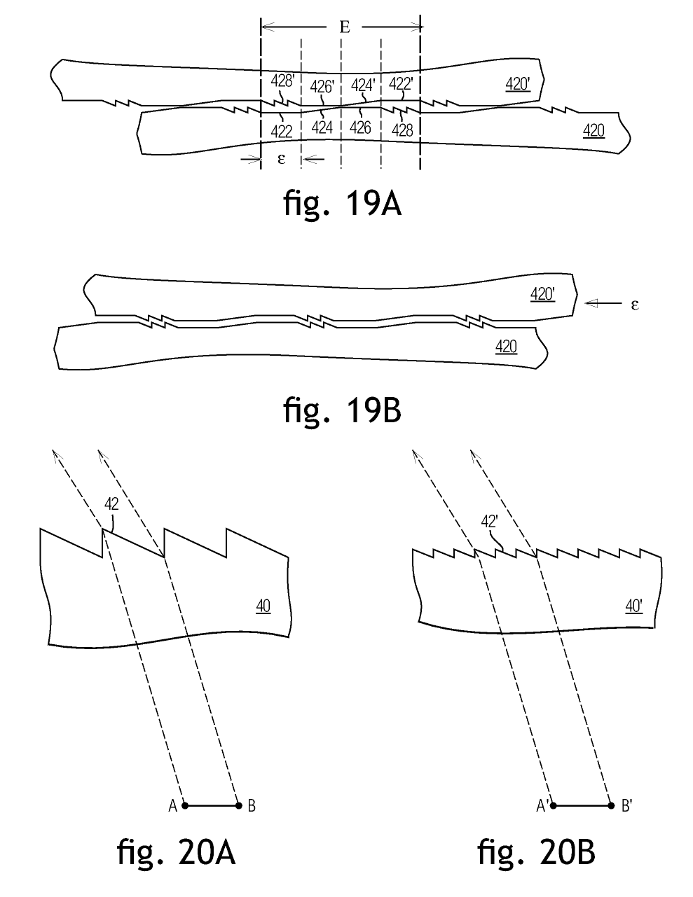

FIG. 19A shows facing four-facet fresnel arrays 420, 420′ having four angular zones 422, 424, 426, 428, and 422′, 424′, 426′, and 428′. Facets 422 and 422′ are each divided into three subfacets to reduce the depth of the prism relief. FIG. 19B shown that relative displacement through e makes all facets and subfacets parallel with their opposite counterparts.

FIGS. 20A, 20B demonstrate a general advantage of fresnel prism display component 40 when the slope is relatively steep. The region of the display plane AB in FIG. 20A and sampled by prism element 42 is reduced by angular vignetting, especially at marginal viewing angles. Such extreme viewing angles may be encountered in user-tracking 3D display systems. When the same area of the prism array is divided into subfacets 42′, sampled region A′B′ will be of increased transverse dimension to AB, which can reduce cropping of the sampled region of the display plane that can otherwise lead to moire banding. As the shapes are mathematically similar, the percentage of clear aperture is unchanged.

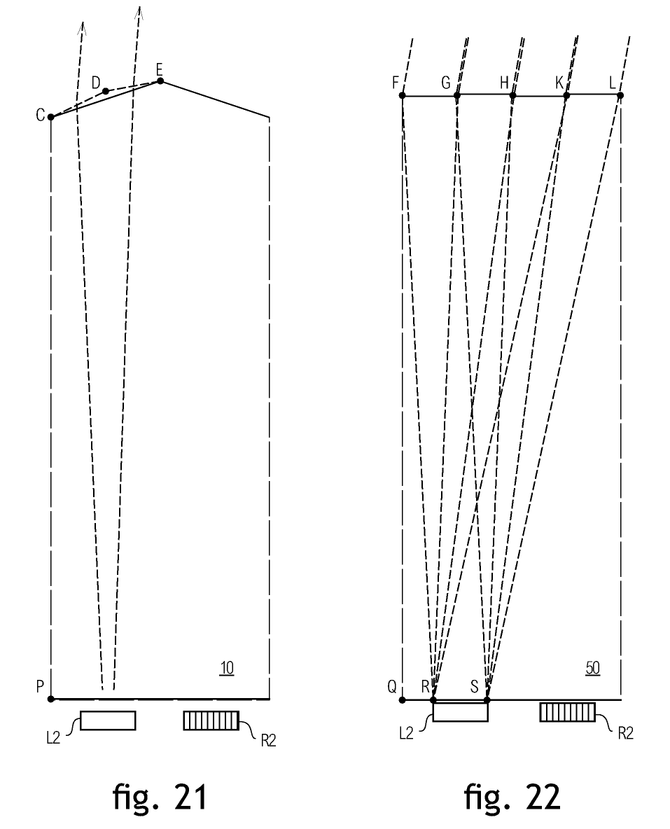

FIG. 21 illustrates how two-facet array 10 can conceptually be modified by altering profile CE to profile CDE. Visual data directed to the left perspective then has its origin only from within a plurality of left display areas L2, while the optical thickness of the system is effectively unaltered. Rather than being limited at the L/R cell edges, as shown in FIGS. 1 and 2, and here suggested by cell limit P, the visually sampled region of the display plane can be kept to about one quarter of the element width. The right half of the prism element may be similarly modified to constrain the area sampled by the right eye to the shaded width R2.

FIG. 22 shows an abstraction of this design without the presumption of continuous facet slopes or contiguous facet edges. Because the system thickness is large relative to the facet length, facets associated with segments FG, GH, HJ, and JK may be displaced somewhat from their theoretically ideal design thickness and still provide a reliable result. It may be understood that refractive facets located in this vicinity, even if formed on separate but facing surfaces, could have an analogous effect to a monolithic prism array, while adding a degree of freedom to the design process. This degree of freedom may be used to derive switchable 2D/3D arrays.

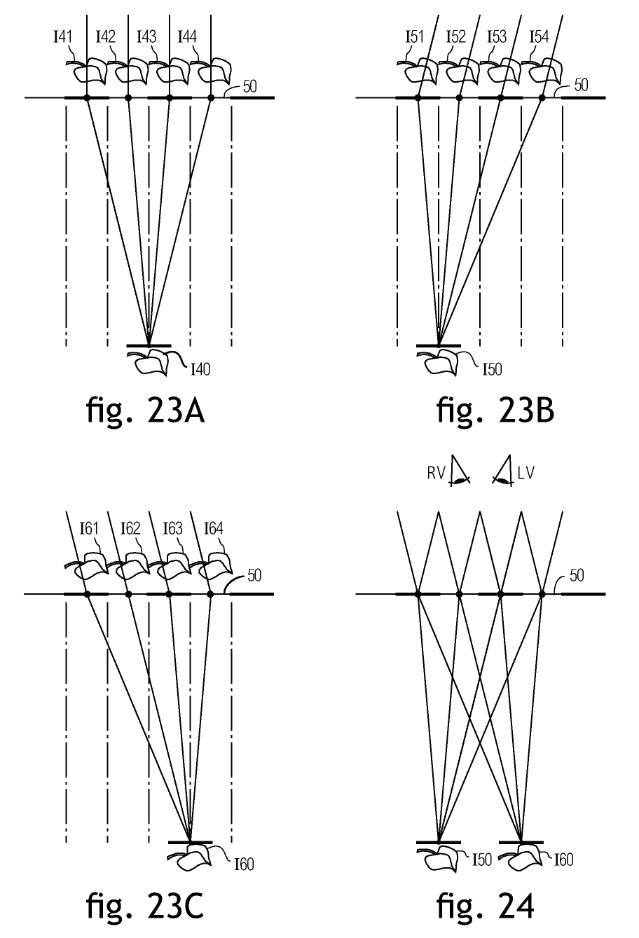

FIGS. 23A-23C schematically show the performance of any arbitrary four-facet prism array formed according to one embodiment when operated in 3D mode. An arbitrary image, represented by the icon of center leaf icon I40 is shown on the optical axis of display cell 50. Given proper facet slopes, a centered monoscopic viewer would see four identical optically replicated images, shown here as I41, I42, I43, I44. Within the limits of diffraction, the prisms repeat whatever visible content occupies the central quarter of the display plane. This optical multiplication is preserved when the content is viewed from an off-axis location. FIG. 23B illustrates left leaf icon 150 shifted to the center of the left half of display cell 50 and duplicated at I51, I52, I53, I54. FIG. 23C illustrates that the effect is independent of the angular bias on the lateral axis of the display. Right leaf icon I60 is reproduced four times at I61, I62, I63, and I64.

FIG. 24 shows that differing image data may be included within each prism array cell. This permits right and left view data to be encompassed within one display cell. While a recognizable image of a leaf is used here for the purpose of demonstration, more commonly the cell will include image data quantized as substantially rectangular pixel or subpixel units.

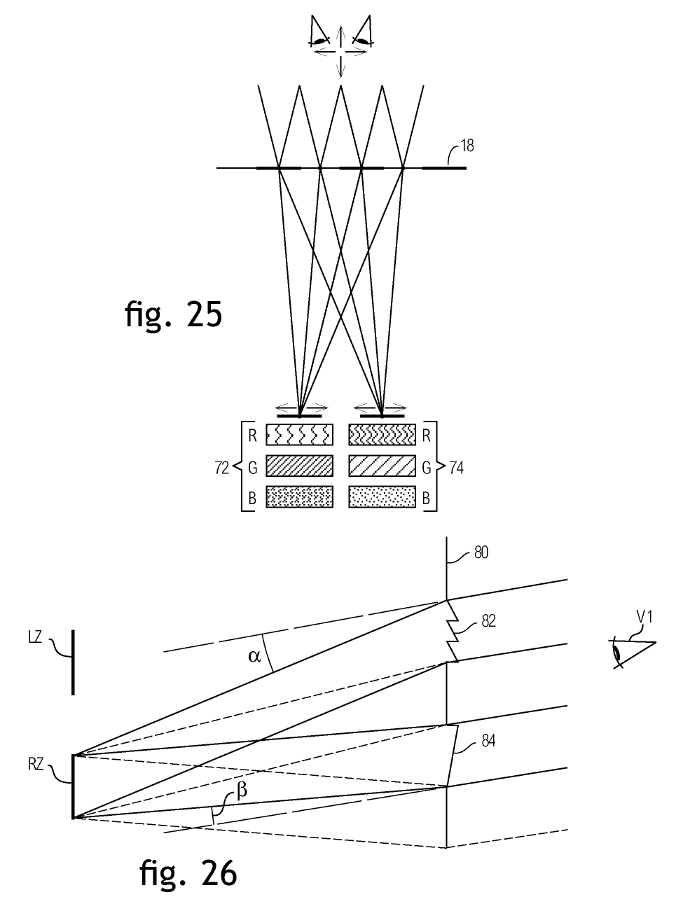

FIG. 25 shows diagrammatic quantized display 18 in which one right-pixel RGB triad 72 and one left-pixel RGB triad 74 are assigned to one four-faceted element. The differing densities in the shadings of the red, blue and green (RGB) subpixels suggest that differing luminosity values may be provided for left and right pixels. It may be understood that the degrees of viewing freedom described in FIGS. 5A, 5B, and 5C pertain to such quantized displays. The degrees of freedom are suggested by the arrows in FIG. 25. In this embodiment, the limits within which the display may be viewed and remain free of moire or pseudoscopy are set by the matrix between the pixel or subpixel apertures.

FIG. 26 shows one schematic asymmetric prism array 80, effectively half of a switching 2D/3D prism system. Facets 82, 84 must direct light from right zone RZ to viewer's eye VI along two distinct optical pathways. The opposite facing prism array (not shown here), typically of identical geometry, performs a similar task for two other optical pathways. Four complementary pathways must also transmit light from left zone LZ to the other eye (not shown). The design is not constrained by a single viewpoint and must take in to account the viewer's eye separation and viewing distance to provide adequate 3D performance. External defection angles, such as a and b, can relate the binocular viewing axes to the system thickness, and may be used to reliably derive the array geometries. One design method is presented in the following discussion.

In practice, various implementations of one embodiment may be extended from the original case of a simple two-faceted prism system. The refractive effect of the derived prism arrays may then be distributed between two surfaces in the manner illustrated previously, so that the stereoscopic division of the optical pathway can be electively disabled. The division of the light deflecting function, depending on the design, may be made either between two optically aligned surfaces, or between differing spatial positions. Integrated solutions are also possible, provided a consistent difference in deflection is made to occur for the right and left visual pathways.

In this derivation, it is convenient to envision the reciprocal property of optical systems, and devise a design on the retrospective imaginary model in which the eyes are posited as the emitters, rather than the actual situation of the display elements. In this manner, the sight-lines may be traced retrospectively from an anticipated viewer position to the graphic back plane in order to determine which areas of the display structure will be sampled by the right and left eyes.

In an exemplary implementation of one embodiment, a single symmetric biprism array of the type shown in FIG. 1 may be first considered. The prism array is hypothetically proposed to anticipate a predetermined interocular angle. The interocular angle is defined as the angular separation of the eyes with reference to a particular position on the display, typically the center. In this proposition, the deflection angle through one facet that is made equal to half the angular separation between the two eyes. The deflection angle is the degree of deviation of a ray from its original direction

Assuming an average human interpupillary spacing i of 65 mm, an interocular angle C of 10° is associated with a particular viewing distance by:

Dv=(65 mm/2)*[1/tan(X/2)]

### Therefore, for χ=10°,

Dv=32.5 mm*1/tan 5°=371 mm(˜14.6″).

An interocular angle may similarly be derived from a predetermined viewing distance. Once these design parameters are chosen, the relative refractive index hR at the prismatic interface must be decided upon. According to Snell's Law,

η₁ sin θ₁=η₂ sin θ₁.

This relative index for a given wavelength is defined by the extension of Snell's law:

η_{R} sin θ₁=sin θ₁/sin θ₂,

where θ₁ is the angle between the incident ray and the surface normal at the interface between two materials, and θ₂ is the angle between the refracted ray and the same surface normal. The prism deflection angle Φ is defined by the difference between the angle of incidence and the angle of refraction, so Φ=θ₁−θ₂.

According to Snell's law, where the first material is a vacuum, η is taken to be the characteristic refractive index of the second material.

In one embodiment, the commonly utilized index range is expected to be between 1.45 and 1.65, as range this includes the most commonly employed polymers and glasses. Other materials outside this range may also be included, such as widely known liquid crystals that can be electrically induced to alternate between values of depending on the orientation of the crystals. Axial values of η for current LCs can be made to vary by approximately 0.3, typically between η=1.5 and η=1.8.

For the purpose of this example, an arbitrary solid material having a refractive index of 1.5 is elected, and a design wavelength in the middle of the visible spectrum, 588 nm, is chosen. For the purposes of design development, the optical pathway may be traced in reverse from the observer to the display plane.

In various embodiments, X is the given as the full interocular angle, and χ the interocular half-angle (X/2=χ). The angular slope σ₁ required to yield a deflection angle (ψ₁) equal to χ at the facet having the greater angle of incidence is established by the relationship, where θ_{F} is the angle of incidence on the facet having the greater angle of incidence for χ and θ_{G} is the resulting angle of refraction, as defined relative to the facet's normal,

χ=ψ₁

σ₁=θ_{G}−ψ₁,

where θ_{F} is the angle of incidence on the facet having the greater angle of incidence for χ and θ_{G} is the resulting angle of refraction, as defined relative to the facet's normal. In this case, it may be understood that the angular slope of elements 12, 14 in FIG. 1 must be equal to the difference between the angle of incidence and half the angular separation between the eyes (χ) at the targeted viewing distance. For η=1.5, and a prism operating in air, angle of incidence that produces a deflection angle of 5° is approximately 14.815°. The required slope of the prism facet is therefore approximately 14.8°−5°, or approximately 9.8°.

The requisite thickness T may be determined by tracing rays through the opposite facet and establishing the intersection with rays refracted at the first facet. The opposite face of the biprism is formed at a symmetrical slope. The angle of incidence θ_{Q} in on the opposite facet is therefore 9.815°−5°, or approximately 4.8°. The refracted angle θ_{R} relative to the surface normal on this second prism facet is therefore 3.208°, or approximately 3.2°. Because rays through the first facet within this optical model are deflected at an angle equal to χ, rays within the prism component and associated the first facet 12 will be substantially perpendicular to the display plane. Rays within the prism array that are associated with the second facet will deflect toward those perpendicular rays at a second defined angle. This angular departure from the perpendicular of the display plane may be assigned a general value ρ. In this case a particular value ρ₁ is given where

ρ₁=σ₁−θ_{R},

an angle of 9.815°−3.208°, or ρ₁=6.607°. Rays traveling through the two faces of the biprism element will be substantially coincident on a plane defined by the point of intersection of these two paths. Presuming all intervening materials have a refractive index of 1.5, and defining the width of the prism element as W, the plane of coincidence occurs at a thickness T where

T=W/2*1/tan ρ₁.

If the prism element is designed to overlie two 200μ pixels, w=200, and optical thickness T, according to the above calculation, equals 1.727 mm. T is measured from the center point of the facets. An array of the type shown in FIG. 1 will divide a display into right and left views, at a viewing distance of 371 mm, when the refractive index is 1.5, the symmetrical facet angle is 9.8°, and the optical thickness T is 1.727 mm. The system length in any case is typically measured from the transverse midpoints of the facets along an axis perpendicular the display plane.

To produce a convertible display of the type shown in FIGS. 6 and 7, the slope is divided equally into biprism relief surfaces having equal opposing slopes, on each of two arrays, of 4.9°. When the apices of the prism elements are aligned, as in FIG. 6, an effective cumulative slope of approximately 9.8° is created. When the arrays are displaced through a relative distance of 200μ, the valleys on one array are aligned with the apices of the other, as in FIG. 7, and no meaningful deflection occurs.

These values may be extended to examples in FIGS. 8, 9A, 9B, 10A, and 10B. In this case, the full prismatic effect, here a slope of 9.8°, is carried by only one facet within a given optical path. This configuration also allows the prismatic effect to be disabled, and it will be seen that, furthermore, its asymmetry allows the optical nulling property to be extended to designs with three or four facets.

Systems with Three Optical Paths Per Cell

Systems providing three our four optical paths within each cell may then be extended from this model. The slope of facets 344 and 344′ in FIGS. 17A, 17B of the functional equivalent of a three-facet array are equal and opposite. They can be disposed in either stereoscopic or monoscopic mode. The angle defined by

ψ₂=χ+sin⁻¹[(W/12)/T)]

establishes the slope value. In each constituent prism array, the facets are intermediated with flat areas of twice the facet width. If a refractive index of 1.5, an element width of 0.4 mm, and a thickness of 1.727 mm are maintained,

χ₂=5°+1.11°≈6.11°

The incident angle that yields a deflection angle of 6.09 degrees at an interface having a relative refractive index of 1.5 is about 17.99°. Angular slope σ₄ of the outer facet of the four-facet array is therefore about 14.54°, since, by Snell's Law

6.11°=17.99°−sin⁻¹[(sin 17.99°)÷1.5],

and therefore

σ₂=17.99°−5°=12.99°.

To make the faceted surfaces without fresnel steps, the relief must effectively be translated through an angle equal to

tan⁻¹(tan σ₂/3),

so for σ₂=12.99° the angular shift is 4.40°. When the element profile is rotated through this angle the end points of the asymmetric facets can be made coincident with the end points of neighboring elements, and facets may be contiguous across the array.

Adding this angular value to the two members of the series 0, 12.99, yields the slopes 4.40°, 8.59 for a array which provides three optical pathways in while 3D mode, and which can also be made without any optically inactive surface features. The minus sign indicates a change in the direction of slope about the perpendicular to the display plane.

Systems with Four Optical Paths Per Cell

A component array shown in FIG. 26, which yields four optical pathways in 3D mode, can be derived by specifying an increased deflection angle ψ₃ and a decreased deflection angle of ψ₄ derived from c by the functions

ψ₃=χ+sin⁻¹[(W/8)/T)], and

ψ₄=χ−sin⁻¹[(W/8)/T)].

The specific deflection angles in the present example are

ψ₃=5°+1.659°≈6.66°, and

ψ₄=5°−1.659°≈3.36°.

The incident angle that yields a deflection angle of 6.66 degrees at an interface having a relative refractive index of 1.5 is about 19.54°. Angular slope σ₄ of the outer facet of the four-facet array is therefore about 14.54°, since, by Snell's Law

6.66°=19.54°−sin⁻¹[(sin 19.54°)÷1.5], and therefore

s4=19.54°−5°=14.54°.

Similarly, the inner facet slope must be

3.36°=19.54°−sin⁻¹[sin(19.54°)÷1.5], and therefore

σ₂=(10.00−χ1)]=5.00°.

To make contiguous faceted surfaces without steps, the relief must effectively be translated through an angle equal to

ω tan⁻¹(1/tan σ₃−1/tan σ₄)÷W,

where ω is the facet width. Substituting the preceding values,

[(0.1 mm)*(tan⁻¹(0.259−0.087)]÷0.4 mm=2.44°.

Adding this angular value to each member of the series 0°, 5.00°, 0°, and −14.54° yields the series 2.44°, 7.4°, 2.44°, and −12.06 for a four-faceted array which can be made of contiguous facets without any optically inactive steps. Additional rounded values may be understood by the following Table 1.

TABLE 1

| | | | | | | | two | | | | | |
|---|---|---|---|---|---|---|---|---|---|---|---|---|
| relative | | | DV | DV | W | T | facet | three facet | | four facet | | |
| index | C | c | mm | in. | mm | mm | s1 | s2 | contiguous | s3 | s4 | contiguous |
| hR = 1.50 | 10° | 5° | 371 | (14.6) | 0.4 | 1.727 | 9.8° | 13.0° | 4.4°/−8.6° | 14.5° | 5.0° | 2.4°/7.4°/2.5°/−12.1° |
| | 8° | 8° | 465 | (18.3) | 0.4 | 2.155 | 7.9° | 10.4° | 3.5°/−6.9° | 11.7° | 3.9° | 2.0°/5.9°/2.0°/−9.7° |
| | 6° | 3° | 611 | (24.0) | 0.4 | 2.881 | 5.9° | 7.9° | 2.6°/−5.3° | 8.9° | 3.0° | 1.5°/4.5°/1.5°/−7.4° |
| hR = 1.55 | 10° | 5° | 371 | (14.6) | 0.4 | 1.784 | 8.9° | 11.8° | 4.0°/−7.8° | 13.3° | 4.5° | 2.3°/6.8°/2.3°/−11.0° |
| | 8° | 4° | 465 | (18.3) | 0.4 | 2.226 | 7.2° | 9.5° | 3.3°/−6.2° | 10.7° | 3.6° | 1.8°/5.4°/1.8°/−8.9° |
| | 6° | 3° | 611 | (24.0) | 0.4 | 2.941 | 5.5° | 7.2° | 2.4°/−4.8° | 8.1° | 2.7° | 1.4°/4.1°/1.4°/−6.7° |
| hR = 1.60 | 10° | 5° | 371 | (14.6) | 0.4 | 1.842 | 8.2° | 10.9° | 3.7°/−7.2° | 12.2° | 4.1° | 2.1°/6.2°/2.1°/−10.1° |
| | 8° | 4° | 465 | (18.3) | 0.4 | 2.297 | 6.6° | 8.8° | 3.0°/−5.8° | 9.9° | 3.3° | 1.7°/5.0°/1.7°/−8.2° |
| | 6° | 3° | 611 | (24.0) | 0.4 | 3.051 | 5.0° | 6.4° | 2.1°/−4.2° | 7.4° | 2.5° | 1.2°/3.7°/1.2°/−6.2° |

Table 2 refers the prism array properties to specific figures.

TABLE 2

| 2D/3D ARRAY | |
|---|---|
| PROPERTIES | FIGS. |
| two-facet contiguous | 6, 7 |
| two-facet asymmetric | 10A, 10B |
| two-facet fresnel | 8, 9A, 9B, 10A, 10B |
| three-facet contiguous | 13A, 13B |
| three-facet asymmetric | 13A, 13B, 14, 15, 16, 17A, 17B |
| three-facet fresnel | 14, 15, 16 |
| four-facet contiguous | 18A, 18A |
| four-facet asymmetric | 18A, 18B, 19A, 19B, 26, 27, 30 |
| four-facet fresnel | 19A, 19B, 26, 27, 30 |

To establish the optimal degree of difference between the pitch of the prism array and the pitch of the image data fields on the display plane, angle of a sight line from the near side eye to the outermost element of the display may be determined by

tan[(Z/2−i/2)/T],

where Z is the horizontal dimension of the active display area. Given a display 200 mm in width, a viewing distance of 371 mm, and again assuming an average human interpupillary spacing i of 65 mm, the line of sight from the eye nearest the given edge of the display is arrives on a prism element at an angle of 10.48°. Taking the 9.82° angular slope as the design basis, the output angle of from the element to the eye is

10.48°+9.82°=20.30°.

The angle of light within the η=1.5 refractive material, at the facet normal, is therefore by Snell's law 13.37°. The angle relative to the display plane is therefore

13.37°−9.82°=3.55°.

The axial error on each side of the display plane, assuming a fixed 400 mm prism element, is therefore

tan(3.55)*1.727 mm=0.107 mm.

The display width must be increased relative to the prism array by the ratio

200.214/200=1.00107

if the sightlines are to be accurately and consistently established from the display plane to an observer located at the stated position. The display cell pitch may be increased to 400.428μ while the element pitch is retained at 400 m, or, inversely, the element pitch may me reduced by a factor of 0.99893 to 399.572 for a predetermined display cell pitch of 400μ.

Alternately, the display itself may be curved to produce the alignment. The slope of the prisms may also be made progressively more asymmetric towards the outer edges of the display. In either of these two cases, the pitch of the prism element and the display cell may electively be made equal.

These geometrical relationships may be diversely solved and expressed. The preceding calculations are therefore only guidelines, as variables such as idiosyncratic eye spacing in the targeted viewer population, predictable ergonomic values, additional optical layers, display laminations having diverse refractive indexes, chromatic dispersion effects, and manufacturing tolerances can all affect the ultimate optimization of the design.

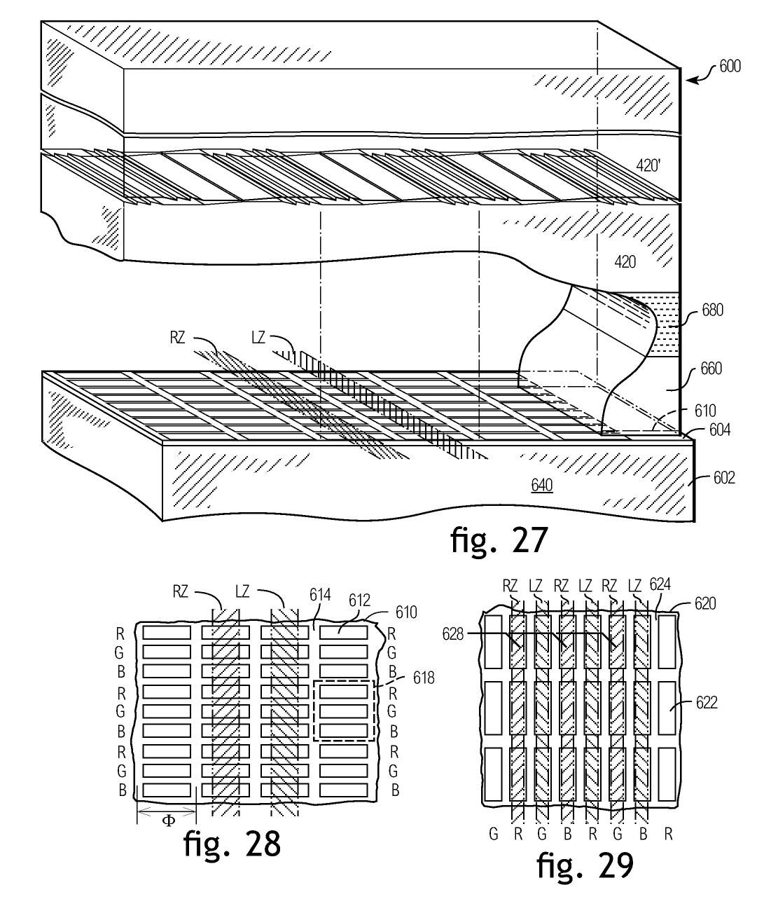

FIG. 27 shows an exemplary flat-panel display formed according to one embodiment. 2D/3D display 600 is shown having prism arrays described in FIG. 19A and 19B. The arrays are shown in a relative position that enables 3D mode. The illustration is consistent with the practice of thin-film transistor (TFT) LCD production, although other types of displays, such as organic LCDs, electroluminescent panels, plasma displays, or field-emission devices can have similar features. Because the 3D function is active, light emitted from shaded zones RZ and LZ is directed to the right and left eyes respectively.

In the illustrated case, TFT-LCD glass 640 has formed upon it TFT display circuitry 604. Color filter array 610 is formed upon color filter glass 660. Polarizer 680 is typically adhered to the outer surface of the color filter glass, but can be at diverse locations, so long as it is interposed between the liquid crystal layer and the viewer. Here, facing lens arrays 420 and 420′ are shown disposed immediately upon the polarizer. The prism arrays are shown being made of a continuous material. However, the prism arrays need not be monolithic, and may instead include polymer-on-glass, solgel on glass, polymer coextrusions, coatings, or diverse optical laminations.

FIG. 28 shows the display plane color filter pattern in more detail. The color filter pattern includes subpixel apertures 612 and black mask 614. An RGB filter pattern is superimposed on the black mask in a pattern of horizontal stripes. LCD pixel triad 618 may be defined as any grouping of three neighboring pixels within the same column. The display has a predetermined pitch F. The most common current practice is to use a vertical stripe pattern. While such a configuration as shown may be the result of custom fabrication, it will be understood that it may often be more economical to turn the display to the orientation shown so that the data lines and color filter run horizontally. Rasterized digital image data is merely transposed through 90° so that it is presented in its proper aspect.

When seen from the targeted viewer distance, the eyes will access light in a selective manner from regions identified by RZ and LZ. The bars on the black mask are typically narrower where they cover only data lines, so that, while the overall aperture ratio of the mask may be only 50%, the aperture ratio over the visually sampled area may be 75%. In a system having this configuration, the relative perceived brightness would increase by 50% over the same device operated as a conventional 2D display. This feature may be used, for example, to reduce backlight power demands or to improve viewing in ambient light. Activation of the 3D mode may be made to concurrently induce a brightness adjustment, so that the measured output brightness is the same as in 2D mode.

FIG. 29 depicts a design in which RGB stripe filters are oriented vertically, and RGB pixels are interlaced. An alternate configuration is shown in FIG. 29. In this design, RGB stripe filters are oriented vertically. Vertical color filter array 620 has vertically elongate apertures 622 defined by vertical stripe filter mask 624. The scale of the prism arrays (not shown) has been reduced by a factor of three, so that right and left zones are created in each neighboring column of pixels. It may be understood from interlaced RGB pixel 628, which includes red, green, and blue data for the right-eye perspective, that in spite of the scale difference, this design can yield an analogous effect to the previous display, at the same design distance. This embodiment can yield an optical system thickness of one third the thickness of the previous system. This embodiment will also exhibit enhanced brightness.

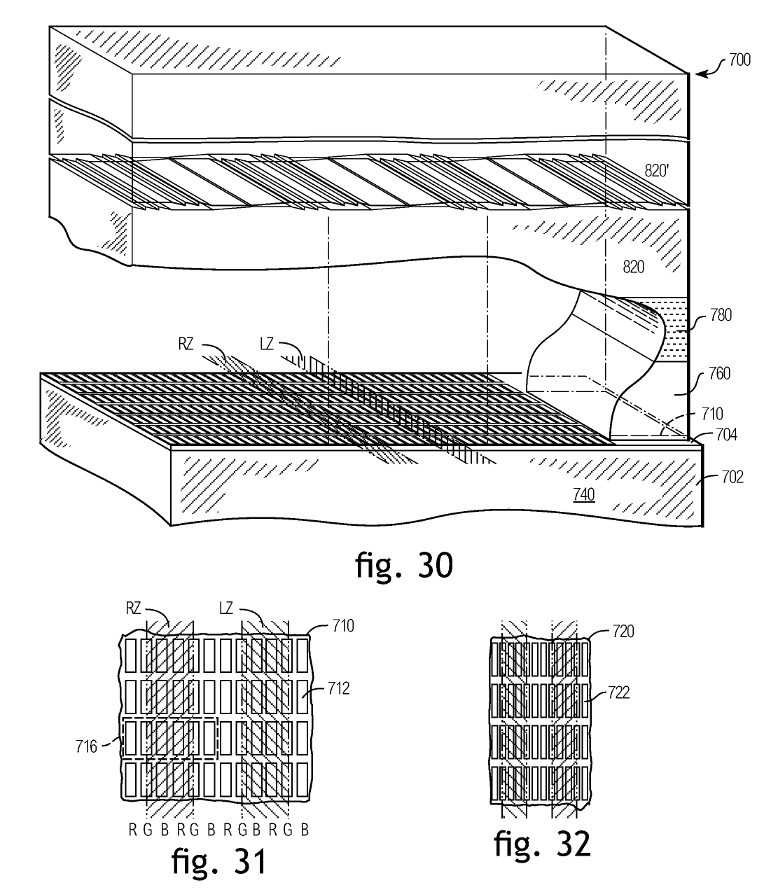

FIG. 30 shows a system using four pixels per cell that enables highly robust active updating of the display at the subpixel level. While many displays within one embodiment may be updated to adapt to a known viewer location, an additional variation is shown in FIGS. 30 and 31 which enables highly robust active updating of the display at the subpixel level. In redundant-pixel display 700, six subpixels at any given moment are associated with each of the two views. Redundant-pixel display glass 740, redundant-pixel display TFT layer 704, redundant-pixel display color filter glass 760, and redundant-pixel display polarizer 780 are analogous to features in FIG. 27. Color filter glass 760 is located on the observer side of the TFT glass. Polarizer 780 is adhered to the filter glass. Color filter array 710 includes a plurality of apertures 712. Relative to the display configuration shown in FIG. 27, however, the prism array is twice the scale relative to the pixel pitch. Inner prism array 820 and outer prism array 820′ are geometrically similar to their counterpart arrays in FIG. 27.

FIG. 31 shows the display plane color filter pattern of the display FIG. 30 in more detail. Redundant pixel domain 716 can as a result include six subpixels, each including subpixels alternating laterally in a succession of red, green, and blue elements. If this set of subpixels is provided with image data having the common output values, a buffer zone may be created about the viewing zone so that movement of the viewer does not immediately cause the eyes to fall into neighboring subpixels with differing view data. Because the region sampled at any location within redundant pixel domain 716 contains all the RGB data associated with the particular view, the viewer is free to observe the display from a wide range of positions without the appearance of moire. Right zone RZ intersects two green subpixels within redundant pixel domain 716, but because their output is the same, the sampled region will not vary in visible color values.

The sensitivity to viewer position is also reduced in this embodiment. However, it is useful to be able to freely define the pixel location on the display back plane in a way that further increases the range over which the display may be successfully viewed. Tracking of the observer's position can be provided by various input devices. For example, video-based tracking can be performed by an inexpensive camera such as those currently enabled by or embedded in electronic devices such as desktop and laptop computers, handheld digital assistants, interactive game systems, and cellular phones.

It may be understood that redundant pixel domain 716 may be freely updated, based on the tracking input data, at the subpixel level. The color sequence for the pixel domain depicted is RGBRGB. The color sequence for a given redundant pixel domain may equally be GBRGBR or BRGBERG. The tracking process would be used to update the raster definition of the redundant domains so that the visually accessed angular viewing zones remain optimally centered on the multipixel domains. Furthermore, it may be understood that view data presented on the display may also be updated in response to the known viewer location. A parallax effect can be presented that is independent of the resolution of the display. Because the motion parallax is created at an electronic level, it is not limited by the resolution or the optics of the panel. The active updating of the viewpoint may be made to occur on the vertical axis as well as the horizontal. The system may be devised to electively present horizontal parallax or full parallax, depending on user needs and source data.

The domains illustrated would suggest RGBRGB subpixel sequences for both the right and left viewing zones RZ and LZ, since these domains would be centered on the sampled regions. However, the observed subpixel sequences for the right and left eyes do not need to be the same, so a considerable degree of freedom can exist in the observer's motion. Because the system is free of magnification, which usually varies with the axis of view, the frequency of the optical filter and the frequency of the display can be made to have an integer ratio that remains constant over a wide. System within one embodiment has been found capable of tracking readily over 60°, and can successfully isolate right and left views over as much as 100°.

FIG. 32 shows a variation in which pixel apertures 722 upon filter array 720 are made expressly elongate so that six subpixels can be included within a square, rather than rectangular, redundant pixel domain.

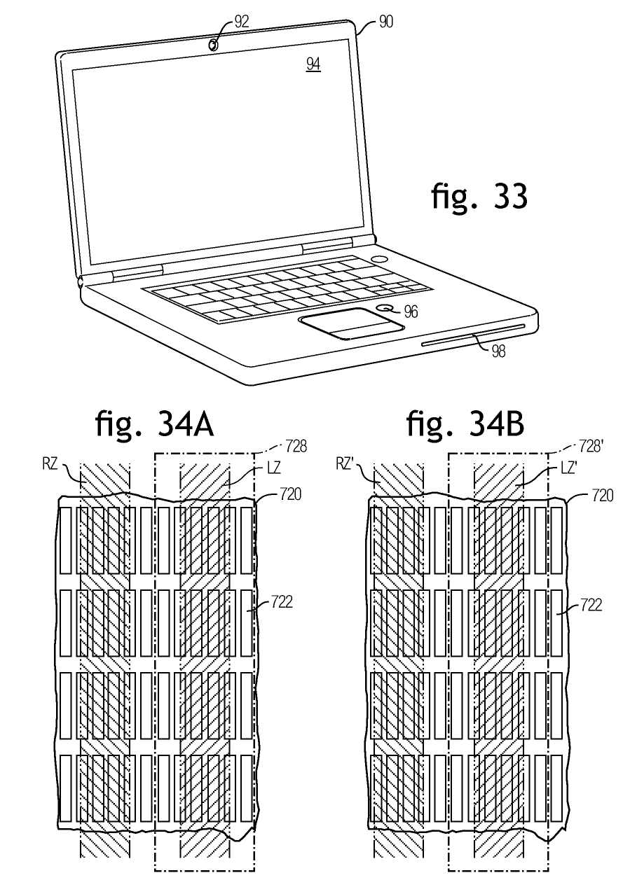

The operation of this type of static but active system is described in further detail with reference to FIGS. 33, 34A, and 34B.

FIG. 33 shows notebook computer 90 having a 2D/3D display screen 94 formed according to one embodiment. Embedded camera 92 provides a source for tracking data but can, for example, also synchronously output images of the user to a second user at a remote location. A switch may include to interactively toggle between 2D and 3D modes, or the stereoscopic image data may be digitally tagged so that the 3D mode is automatically activated when 3D data is loaded onto the display. Prerecorded stereoscopic image content in the form of still imagery, video clips, or DVD movies may be provided to the device through data input slot 98, or from other analog or digital sources.

FIGS. 34A, 34B show in detail how the redundant pixel domains may be updated. The two figures depict the same region at the display plane of 2D/3D display screen 94. In FIG. 34A, redundant pixel domains are disposed in six-subpixel-wide columns 728. Tracking of the user position defines the pixel column location at the raster locations shown. If the user moves to the right relative to the first position, right and left viewing zones, at the display plane, move to the viewer's left. Knowledge of the change in viewer position provided by the camera system and tracking software allows the raster grid to be conscientiously redefined at the subpixel level. New positions of the viewing zones RZ′ and LZ′ can be actively accommodated by the redefinition of raster in the manner of typical updated six subpixel-wide column 728′. In FIG. 34B, it may be seen that the master raster definition has been shifted by one subpixel to the left, and the left view zone LZ′ is again centered on a six-subpixel-wide column. The system is therefore highly tolerant of abrupt changes in viewer position, as a subpixel buffer persists through the updating process. Again, the updated content may repeat that shown at the prior raster definition, but it may also include an update of the view perspective. This update need not be, but may be, synchronous with changes in the raster definition.

Diverse implementations may be envisioned beyond the included specifications and drawings. Displays may be monochromatic, grayscale, or may have field-sequential color. Pixel and subpixel aspect ratios and contours can vary greatly. The display plane need not be the original display image but may be projected from a physically discrete imaging device. Prism components may be divided and diversely laid out in an optical array without departing from the spirit of one embodiment.

The prism components may be sufficiently small to be diffractive in effect, and wavelength-specific structures introduced to counter diffractive wavelength dispersion. The relative physical displacement of the arrays may be imparted directly by a user, and diverse surface features and linkages may be used to promote ease of use. Electromechanical actuation can be imparted through electrical comb arrays, electroactive materials, voice coil actuators, latching mechanical relays, piezoelectric materials, solenoids, or stepper motors.

Prism arrays may be held in proximity by various means, such as forming arrays to a curve so that they are slightly tensioned when flat. One array may be formed on a thin film and retained in a sleeve or channel. One or both arrays may be electrostatically activated to promote proximity. During a tracking session, an inset in the screen can show a regularly updated image of multiple users, so the image content can be selectively targeted to a given audience member by selection of the chosen viewer's image. In general, one embodiment is not limited by the detailed description in this application, but instead is to be defined by specific claims to be appended to this application.

Operations for various embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

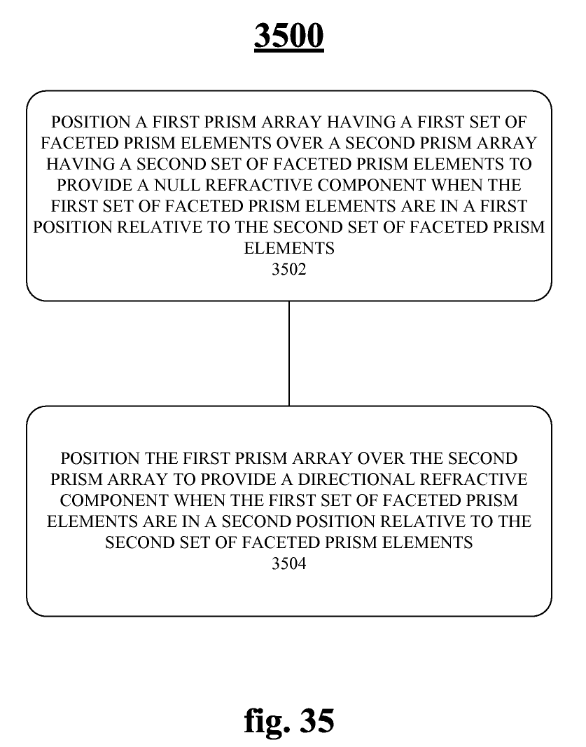

FIG. 35 illustrates a logic flow 3500. Logic flow 3500 may be representative of the operations executed by one or more embodiments described herein. As shown in FIG. 35, the logic flow 3500 may position a first prism array having a first set of faceted prism elements over a second prism array having a second set of faceted prism elements to provide a null refractive component when the first set of faceted prism elements are in a first position relative to the second set of faceted prism elements at block 3502. The logic flow 3500 may position the first prism array over the second prism array to provide a directional refractive component when the first set of faceted prism elements are in a second position relative to the second set of faceted prism elements at block 3504. The first prism array and second prism array may provide two dimensional resolution when in the first position and three dimensional resolution when in the second position. The embodiments are not limited in this context.

Various embodiments may be implemented with any electronic device having an electronic display. Examples of electronic devices may include without limitation a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, mobile computing device, smart phone, digital camera, digital camera and recorder (camcorder), mobile video game device, portable video game device, handheld video game device, handheld video game controller, vehicle navigation systems, motorized vehicles, wearable computers, helmet displays, heads up displays, portable gaming devices, personal electronic devices, eye glasses, handset, wireless access point, base station, subscriber station, mobile subscriber center, radio network controller, router, hub, gateway, bridge, switch, machine, or combination thereof. Embodiments are not limited in this context.

Various embodiments may be implemented with an electronic device having an electronic display, such as a digital electronic display or an analog electronic display. Examples of digital electronic displays may include without limitation electronic paper, nixie tube displays, vacuum fluorescent displays, light-emitting diode displays, electroluminescent displays, plasma display panels, liquid crystal displays, thin-film transistor displays, organic light-emitting diode displays, surface-conduction electron-emitter displays, laser television displays, carbon nanotubes, nanocrystal displays, and so forth. An example for analog electronic displays may include cathode ray tube displays.

Various embodiments may be implemented with a consumer electronics device, such as an analog or digital display device such as a computer monitor, an analog television, or a digital television (DTV). DTV is a telecommunication system and display device for broadcasting and receiving moving pictures and sound by means of digital signals, in contrast to analog signals used by analog television. DTV uses digital modulation data, which is digitally compressed and decoded by a specially designed television set, or a standard receiver with a set-top box, a personal computer (PC) fitted with a television card, a television fitted with a computer or computer interface, and so forth.

Various embodiments may be implemented with portable or handheld gaming devices, such as Nintendo® Gameboy®, Nintendo DS®, Nintendo DS Lite, Sony® Play Station Portable (PSP)®, and so forth. The portable or handheld gaming devices may implement a general purpose or specific purpose processor, memory, an output device such as a display, an input device such as buttons or keys, and other components common to handheld electronic devices. The portable or handheld gaming device may further include gaming or video game software capable of rendering images, video, graphics, text and other multimedia information in a 2D format and a 3D format. The video game software may be capable of switching between the 2D and 3D formats. The switching mechanism may be implemented in response to user commands, automatically based on a configuration of the autostereoscopic display or various rules, or a combination of both.

In addition to their embodiments as planar graphic materials, the prism arrays may be mounted upon or within a functional or ornamental device such as a watch, watchband, bracelet, brooch, pendant, purse, belt, compact, writing instrument, drafting tool, lunchbox, restaurant menu, placemat, mousepad, license plate, lampshade, nightlight, optical data disc, drinking cup, credit card, identification card, gamepiece, toy, sticker, clothing accessory, or souvenir. Prism arrays may be formed as concave, convex, or complex surfaces; angular image data and microimage tiles may be adapted according to the precepts herein described.

Digital source images suitable for use with the prism arrays may include translated computational holograms. The image plane may be a hologram or include holographic regions. Visible data may be derived from invisible processes, as in radar, sonography, X-rays, electron microscopy, nucleomagnetic resonance (NMR), PET or CT scanning, or magnetometry. Disciplines such as statistics, industrial diagnostics, engineering optimizations, product design, cartography, seismography, meteorology, remote sensing, astronomy, medical imaging, video game technology, and molecular modeling may generate data which is most readily appraised as a three-dimensional or animated representation.

Some embodiments may be described using the expression “coupled″ and “connected″ along with their derivatives. These terms are not necessarily intended as synonyms for each other. For example, some embodiments may be described using the terms “connected″ and/or “coupled″ to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including″ and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a first prism array having a first set of faceted prism elements arranged to optically couple with a second prism array having a second set of faceted prism elements, the first prism array and the second prism array to provide a null refractive component when the first set of faceted prism elements are in a first position relative to the second set of faceted prism elements, and a directional refractive component when the first set of faceted prism elements are in a second position relative to the second set of faceted prism elements.

2. The apparatus of claim 1, the first and second prism arrays to provide two dimensional resolution when in the first position and three dimensional resolution when in the second position.

3. The apparatus of claim 1, the first set of faceted prism elements disposed to face the second set of faceted prism elements.

4. The apparatus of claim 1, each faceted prism element comprising multiple facet surfaces, wherein facet surfaces of the first set of faceted prism elements are substantially parallel to opposing facet surfaces of the second set of faceted prism elements when in the first position.

5. The apparatus of claim 1, each faceted prism element comprising multiple facet surfaces, wherein facet surfaces of the first set of faceted prism elements are substantially non-parallel to opposing facet surfaces of the second set of faceted prism elements when in the second position.

6. The apparatus of claim 1, each faceted prism element comprising multiple facet surfaces forming an apex, wherein the apices of the first set of faceted prism elements are shifted relative to the apices of the second set of faceted prism elements when in the first position.

7. The apparatus of claim 1, each faceted prism element comprising multiple facet surfaces forming an apex, wherein the apices of the first set of faceted prism elements are shifted relative to the apices of the second set of faceted prism elements a distance substantially equal to a predetermined prism facet pitch when in the first position.

8. The apparatus of claim 1, each faceted prism element comprising multiple facet surfaces forming an apex, wherein the apices of the first set of faceted prism elements are substantially aligned with the apices of the second set of faceted prism elements when in the second position.

9. The apparatus of claim 1, each faceted prism element having a multiple number of facets, with the number of facets for each faceted prism element corresponding to a level of cross-talk between viewing zones.

10. The apparatus of claim 1, comprising an electromechanical link to couple to the first and second prism arrays, the electromechanical link operative to switch the first and second prism arrays between the first and second positions.

11. A system, comprising:
an electronic display, and
an autostereoscopic display disposed on the electronic display, the autostereoscopic display comprising a first prism array having a first set of faceted prism elements arranged to optically couple with a second prism array having a second set of faceted prism elements, the first prism array and the second prism array to provide a null refractive component when the first set of faceted prism elements are in a first position relative to the second set of faceted prism elements, and a directional refractive component when the first set of faceted prism elements are in a second position relative to the second set of faceted prism elements.

12. The system of claim 11, the autostereoscopic display to provide two dimensional resolution when in the first position and three dimensional resolution when in the second position.

13. The system of claim 11, each faceted prism element comprising multiple facet surfaces, wherein facet surfaces of the first set of faceted prism elements are substantially parallel to opposing facet surfaces of the second set of faceted prism elements when in the first position.

14. The system of claim 11, each faceted prism element comprising multiple facet surfaces, wherein facet surfaces of the first set of faceted prism elements are substantially non-parallel to opposing facet surfaces of the second set of faceted prism elements when in the second position.

15. The system of claim 11, comprising an electromechanical link to couple to the first and second prism arrays, the electromechanical link operative to shift at least one of the first and second prism arrays to form the first and second positions.

16. The system of claim 11, the autostereoscopic display to be attachable and detachable to the electronic display.

17. A method, comprising:
positioning a first prism array having a first set of faceted prism elements over a second prism array having a second set of faceted prism elements to provide a null refractive component when the first set of faceted prism elements are in a first position relative to the second set of faceted prism elements; and
positioning the first prism array over the second prism array to provide a directional refractive component when the first set of faceted prism elements are in a second position relative to the second set of faceted prism elements.

18. The method of claim 17, comprising providing two dimensional resolution when in the first position and three dimensional resolution when in the second position.

19. The method of claim 17, comprising automatically switching between the first position and the second position based on media content displayed on a display.

20. The method of claim 17, comprising shifting apices of the first set of faceted prism elements in a lateral direction a distance substantially equal to a predetermined prism facet pitch to form the first position.
